(19) United States
(12) Patent Application Publication
(10) Pub. No.: US 2022/0049756 A1
(43) Pub. Date: Feb. 17, 2022

(54) COUPLING ARRANGEMENT HAVING A HOUSING AND HAVING AN ABSORBER SYSTEM

(71) Applicant: ZF FRIEDRICHSHAFEN AG, Friedrichshafen (DE)

(72) Inventor: Thomas BAUER, Großbardorf (DE)

(21) Appl. No.: 17/312,486

(22) PCT Filed: Dec. 11, 2019
(86) PCT No.: PCT/EP2019/084602

§ 371 Date: Jun. 10, 2021

(30) Foreign Application Priority Data
Dec. 13, 2018 (DE) 10 2018 221 613.4

(51) Int. Cl. F16F 15/134; F16F 15/131; F16F 15/14; F16H 45/02

(52) U.S. Cl. CPC F16F 15/13469; F16F 15/1315; F16F 15/145; F16H 2045/0284; F16F 15/13164; F16H 45/02; F16H 2045/021; F16F 15/13453

(57) ABSTRACT

A clutch arrangement is provided with a mass damper system having a damper mass carrier and damper masses deflectable relative to the damper mass carrier. The clutch arrangement has a housing having at least two housing parts permanently connected to one another by a fixed connection, at least one housing parts has a cutout for at least one projection of the other housing part. The housing parts are assembled while receiving the damper mass carrier between an axial stop of the cutout of the one housing part and the projection of the other housing part. The housing parts are loaded over the course of producing the fixed connection by a clamping mechanism which acts on the housing parts in direction away from one another and operative axially between one of the housing parts and the damper mass carrier axially supported at the other respective housing part.

### CROSS REFERENCE TO RELATED APPLICATIONS

This is a U.S. national stage of Application No. PCT/EP2019/084602 filed Dec. 11, 2019. Priority is claimed on German Application No. DE 10 2018 221 613.4 filed Dec. 13, 2018 the content of which is incorporated herein by reference.

### BACKGROUND OF THE INVENTION

### 1. Field of the Invention

The disclosure is directed to a clutch arrangement with a mass damper system having a damper mass carrier and at least one damper mass that is deflectable relative to the damper mass carrier, with a housing having at least two housing parts that are permanently connected to one another by a fixed connection, at least one of which housing parts has a cutout for at least one projection of the other respective housing part.

### 2. Description of Related Art

A clutch arrangement of this kind is known from DE 10 2012 219 738 A1 in which FIG. 9 shows a clutch arrangement formed as hydrodynamic torque converter. The housing part having the projection is provided for forming a hydrodynamic component part such as an impeller and, in addition, radially envelops the mass damper system. The projection of this housing part engages by its end facing the other housing part in the cutout of this housing part, the cutout being provided in the circumferential area of this housing part at the radial inner side thereof. Accordingly, the projection and recess overlap radially as well as axially. This contact area of the two housing parts is secured by a fixed connection in the form of a weld so that the two housing parts are permanently connected to one another.

The mass damper system of this clutch arrangement has a damper mass carrier, which has two damper mass carrier elements arranged at an axial distance from one another and which receive damper masses axially therebetween. One of these damper mass carrier elements is fastened to a component part of a torsional vibration damper in the torque transmission path. When strong torsional vibrations are present at this component part of the torsional vibration damper due to strong drive-side excitations, the damper masses execute substantial deflection movements relative to the damper mass carrier. In order to protect the connection of the damper masses to the damper mass carrier, these deflection movements must be limited by a stop that must be robustly constructed in view of the prevailing load.

A vibration damping mechanism having a torsional vibration damper and a mass damper system is known from EP 2 685 127 B1. While the input of the torsional vibration damper is connected to a drive, the output of the torsional vibration damper engages at a damper housing so as to be fixed with respect to rotation relative to it, this damper housing being provided for receiving damper masses so as to be movable relatively. The damper housing is operatively connected to a driven hub via a slip clutch, this driven hub being arranged on a transmission input shaft so as to be fixed with respect to rotation relative to it. The purpose of the slip clutch is to limit the torque transmitted to the transmission input shaft. To this end, in the event that the drive introduces excessively high torques into the vibration damper, an axial spring that provides for the buildup of a static friction through arrangement between the damper housing and the driven hub permits a relative movement between the damper housing and the driven hub and accordingly prevents the respective torque surplus from being transmitted to the transmission input shaft.

### SUMMARY OF THE INVENTION

It is an object of one aspect of the invention to form a clutch arrangement with a housing and with a mass damper system such that relative movements of damper masses of the mass damper system with respect to a damper mass carrier of the mass damper system can be efficiently limited with little technical expenditure.

According to one aspect of the invention, there is a clutch arrangement with a mass damper system having a damper mass carrier and at least one damper mass which is deflectable relative to the damper mass carrier, and with a housing having at least two housing parts, which are permanently connected to one another by a fixed connection, at least one of which housing parts has a cutout for at least one projection of the other respective housing part.

It is particularly important in this regard that the at least two housing parts are assembled such that the damper mass carrier is received between the cutout of the one housing part and the projection of the other housing part, namely, in such a way that, over the course of producing the fixed connection, the housing parts are loaded by a clamping mechanism that acts on the housing parts in direction away from one another and which is operative axially between one of the housing parts and the damper mass carrier which is axially supported at the other respective housing part.

Since the clamping mechanism acts in such a way that the at least two housing parts are acted upon in direction away from one another, the clamping mechanism is permanently preloaded owing to the fixed connection between the at least two housing parts, this fixed connection preferably being effected by a weld. Due to the action of the clamping mechanism between one of the housing parts and the damper mass carrier, the damper mass carrier is acted upon in direction toward the other respective housing part at which the axial supporting of the damper mass carrier is carried out. The static friction operative between the damper mass carrier and the contact surface of the corresponding housing part during this supporting causes the damper mass carrier to be carried along by the housing part during movements thereof around a central axis. However, this is true only until the adhesion limit between the damper mass carrier and the contact surface of the corresponding housing part is reached. Accordingly, when torque surges are transmitted to the housing part that trigger a relative movement of the housing part with respect to the damper mass carrier because the adhesion limit between the damper mass carrier and the contact surface of the corresponding housing part is exceeded, the torque surpluses introduced as a result of these torque surges due to the above-mentioned relative movement are prevented from being transmitted to the damper mass carrier. This results in the following advantage:

When a torque surge is introduced, the damper masses are deflected relative to the damper mass carrier. In order to limit the deflection distance of the damper masses relative to the damper mass carrier, mass damper systems usually have a stop mechanism at which the damper masses abut when a predetermined deflection distance is reached, and the loading of the stop mechanism and of the damper masses increases as the strength of the torque surge increases. Since the stop mechanism is usually made of a material that is appreciably softer than the material of the damper masses for the sake of reducing stop noises, damage to the stop mechanism in particular cannot be ruled out when the introduced torque surges exceed determined values. Insofar as the damper mass carrier can execute a relative movement with respect to the associated housing part in these cases, only torques or torque surges up to a predetermined limiting value determined by the adhesion limit between the damper mass carrier and the associated housing part can reach the damper mass carrier. Accordingly, the deflection of the damper masses relative to the damper mass carrier is limited, and the stop mechanism is protected from damage in this way.

In order to achieve this manner of operation, it is particularly preferable to provide the clutch arrangement with a housing that is provided with the cutout for the projection as well as with the projection itself in the radial outer region of the housing and at an axial end of a housing part facing the other respective housing part, and the housing part having the projection engages with the radial inner side of the housing part having the cutout. The damper mass carrier can be formed with an individual damper mass carrier element or with a plurality of damper mass carrier elements. When the damper mass carrier engages in the cutout of the housing part having this cutout, the damper mass carrier element or damper mass carrier elements of the damper mass carrier are supported at the projection by a side facing the projection of the other housing part and/or are supported at axial securing elements associated with the cutout by a side remote of the projection, while the respective damper mass carrier element is acted upon by the clamping mechanism at the side remote of the support point. In particular, this can result in the configurations below.

If the damper mass carrier has, for example, a plurality of damper mass carrier elements which engage in the cutout of the housing part having this cutout, an advantageous configuration consists in that a damper mass carrier element is supported at the axial securing element associated with the cutout of the one housing part, and a further damper mass carrier element is supported at the projection of the other housing part, while the side of the one damper mass carrier element remote of the axial securing elements and the side of the further damper mass carrier element remote of the projection are acted upon, respectively, by the clamping mechanism which is located axially between the two damper mass carrier elements. Another advantageous configuration is provided when a first damper mass carrier element is supported at the axial securing elements of this cutout, and a further damper mass carrier element is supported at the first damper mass carrier element, while the side of the second damper mass carrier element remote of the first damper mass carrier element is acted upon by the clamping mechanism supported at the projection of the other housing part. In both configurations, it is advantageous when at least the two above-mentioned damper mass carrier elements protrude radially over the at least one damper mass, and at least one of these damper mass carrier elements has at its radial outer side an offset toward the other respective damper mass carrier element.

On the other hand, if the damper mass carrier only has one damper mass carrier element that engages in the cutout of the housing part having this cutout, an advantageous configuration consists in that the clamping mechanism is supported at the axial securing elements associated with the cutout of the one housing part, and the damper mass carrier element is acted upon at its side remote of the projection of the other housing part, while the damper mass carrier element is supported at this projection by its side facing this projection. On the other hand, another advantageous configuration consists in that the damper mass carrier element is supported at the axial securing elements associated with the cutout of the one housing part and is acted upon by the clamping mechanism which is supported at the projection of the other housing part.

Irrespective of these embodiments, an advantageous configuration for the clamping mechanism consists in that this clamping mechanism has an energy storage device with at least one energy storage. A compact construction can be realized with a simple design layout when this energy storage has at least one Belleville washer or at least one wave spring. Alternatively, the at least one energy storage can also be realized in an energy storage device with energy storage carrier elements arranged at an axial distance from one another, the energy storage being received axially between the energy storage carriers. In an advantageous embodiment, this energy storage can be formed as a helical compression spring. However, if a plurality of energy storages in the form of helical compression springs are provided axially between the energy storage carriers, they are arranged at least substantially equidistant from one another in circumferential direction.

### BRIEF DESCRIPTION OF THE DRAWINGS

The clutch arrangement is described more fully in the following referring to drawings. The drawings show:

FIG. 1 is a section through a clutch arrangement with a mass damper system in a two-part housing, wherein the mass damper system has a damper mass carrier with two damper mass carrier elements, which are arranged with an axial offset to one another, one of which protrudes radially over damper masses, which are received axially between the damper mass carrier elements, is received in a cutout of a housing part and is loaded at one axial side by an energy storage device of a clamping mechanism, which energy storage device is arranged in the cutout of this housing part and supported at axial securing elements of this housing part;

FIG. 2 a wave spring as energy storage of the energy storage device shown in FIG. 1;

FIG. 3 as in FIG. 2, but with a Belleville washer as energy storage of the energy storage device;

FIG. 4 as in FIG. 2, but with a Belleville washer stack as energy storage of the energy storage device;

FIG. 5 as in FIG. 1, but with an energy storage device supported at a projection of the other housing part, and the damper mass carrier element arranged in the cutout of this housing part is loaded at the opposite axial side;

FIG. 6 as in FIG. 1, but with a damper mass carrier in which the two damper mass carrier elements radially protrude over the damper masses and are received in the cutout of a housing part, and with an energy storage device supported at a projection of the other housing part, and the adjacent damper mass carrier element arranged in the cutout of this housing part is loaded at the axial side facing the projection;

FIG. 7 as in FIG. 6, but with an energy storage device arranged between the two damper mass carrier elements and supported at the axial sides of the damper mass carrier elements facing one another;

FIG. 8 an energy storage device with energy storage carrier elements which are arranged at an axial distance from one another and which receive axially therebetween an energy storage which is formed in each instance as a helical compression spring; and

FIG. 9 a detail of a helical compression spring acting as energy storage and of a circumferential section of the energy storage carrier elements of the energy storage device.

### DETAILED DESCRIPTION OF THE PRESENTLY PREFERRED EMBODIMENTS

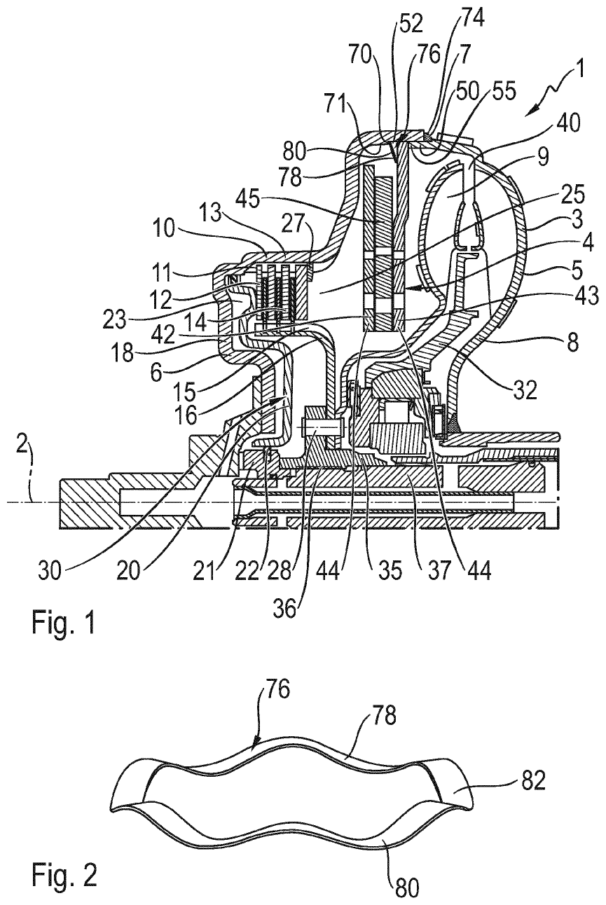

FIG. 1 shows a clutch arrangement 1 which is to be connected to a drive, for example, to the crankshaft of an internal combustion engine, in a manner that not shown. The clutch arrangement 1 has a housing 3 comprising a main housing part, designated in the following as first housing part 5, and a housing cover designated in the following as second housing part 6. The two housing parts 5 and 6 have a fixed connection 74 with respect to one another, which is formed by a weld 7 and are enabled for rotational movement around a central axis 2. The first housing part 5 serves to form a pump 8 which, along with a turbine 9 and a stator 32, are component parts of a hydrodynamic circuit 40. The housing 3 is at least partially filled with fluid medium.

The second housing part 6 has a cutout 52 in the form of a circumferential radial recess at the radial inner side 71 of its circumference. This cutout 52 serves as a receiving area for a damper mass carrier element 43 of a damper mass carrier 44. The damper mass carrier element 43 is arranged at an axial distance from a further damper mass carrier element 42 of the damper mass carrier 44. The two damper mass carrier elements 42 and 43 receive damper masses 45 axially therebetween, these damper masses 45 being moveable relatively. Damper mass carrier element 43 projects farther radially outward than the damper mass carrier element 42 to be received in the cutout 52 of the second house 6. Like the damper masses 45, the damper mass carrier elements 42 and 43 are part of a mass damper system 4.

At its side remote of the hydrodynamic circuit 40, the cutout 52 is formed with a radial transition serving as axial stop 70 and as a limit of the cutout. An energy storage 80 of an energy storage device 78 of a clamping mechanism 76 is axially supported at this axial stop 70 and acts upon the damper mass carrier element 43 by its opposite side, this energy storage 80 being formed as a wave spring 82 shown as a detail in FIG. 2. This damper mass carrier element 43 is axially supported by its opposite side at the free end 55 of a projection 50 of the first housing part 5. Because it is acted upon by the energy storage device 78, the damper mass carrier element 43 is held to frictionally engage the first housing part 5 as long as torques or torque surges acting in circumferential direction remain under the influence of the frictional force generated by the energy storage device 78. However, if the torques or torque surges acting in circumferential direction increase in strength to the extent that they exceed the frictional engagement produced by the energy storage device 78, the damper mass carrier 44 slips through relative to the housing 3 of the clutch arrangement 1 and accordingly limits the relative deflection of the damper masses 45 with respect to the damper mass carrier 44 by a limiting of the effective torques or torque surges. In this way, the mass damper system 4 is effectively protected from damage through overload. For the production of the housing 3, the mass damper system 4 under the influence of the clamping mechanism 76 is brought into the position shown in FIG. 1 relative to the housing 3, in which position the radially larger damper mass carrier element 43 engages in the cutout 52 of the second housing part 6. The projection 50 axially abuts the damper mass carrier element 43 by its free end 55. The two housing parts 5 and 6 are then aligned relative to one another in direction of the extension of the central axis 2, and the fixed connection 74 is formed. In so doing, the preloading of the energy storage 80 of the clamping mechanism 76 is retained.

As is further shown by FIG. 1, the second housing part 6 is formed with an inner toothing 11 in an at least substantially axially extending radial region 10, the drive-side clutch elements 12 being received by this inner toothing 11 so as to be fixed with respect to rotation relative to it. Consequently, the radial region 10 acts as outer clutch element carrier 13. Driven-side clutch elements 14 are provided axially adjacent to the drive-side clutch elements 12 and are received in an outer toothing 15 of an inner clutch element carrier 16 so as to be fixed with respect to rotation relative to it.

A clutch piston 20 is provided axially between an at least substantially radially extending housing wall 18 of the second housing part 6 and the drive-side clutch element 12 located closest to this housing wall 18, this clutch piston 20 being received axially displaceably on a housing hub 21 in a pressure-tight manner by a seal 22. Together with the outer clutch element carrier 13, clutch elements 12 and 14 and inner clutch element carrier 16, the clutch piston 20 forms a clutch device 30.

A pressure space 23 is provided between the housing wall 18 and the side of the clutch piston 20 facing this housing wall 18. On the other hand, adjoining the opposite side of the clutch piston 20 is a cooling space 25 in which the clutch elements 12 and 14 and the inner clutch element carrier 16 of the clutch device 30 are received along with the mass damper system 4 and the hydrodynamic circuit 40.

As a result of a positive pressure in the pressure space 23 relative to the cooling space 25, the clutch piston 20 is displaced in direction of the clutch elements 12 and 14 which are axially supported at the second housing part 6 by their sides remote of the clutch piston 20 via an axial limiting 27. The clutch piston 20 deflected in this way puts the clutch elements 12 and 14 in frictional connection with one another, and the clutch device 30 is engaged. In contrast, a positive pressure in the cooling space 25 relative to the pressure space 23 results in that the clutch piston 20 is displaced in direction away from clutch elements 12 and 14 so that the frictional connection between the clutch elements 12 and 14 is at least reduced, and the clutch device 30 is disengaged.

The inner clutch element carrier 16, like the turbine 9, is connected to a driven hub 35 by riveting 28, this driven hub 35 being connected via a toothing to a transmission input shaft 36 so as to be fixed with respect to rotation relative to it.

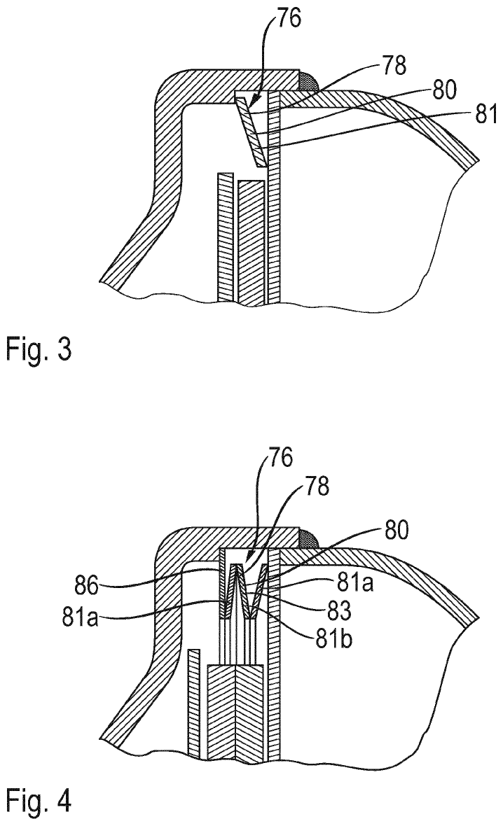

Instead of the wave spring 82 shown in FIG. 1, a Belleville washer 81 shown separately in FIG. 3 or a Belleville washer stack 83 shown in FIG. 4 can be provided as energy storage 80. The Belleville washer stack 83 can have differently oriented Belleville washers 81a, 81b. If the Belleville washer 81a farthest away from the damper mass carrier element 43 is oriented such that it would not engage with the axial stop 70, an energy storage carrier element 86 can also be provided between the latter and the Belleville washer 81a, the latter being axially supported at the energy storage carrier element 86 which, in turn, finds axial support at the axial stop 70.

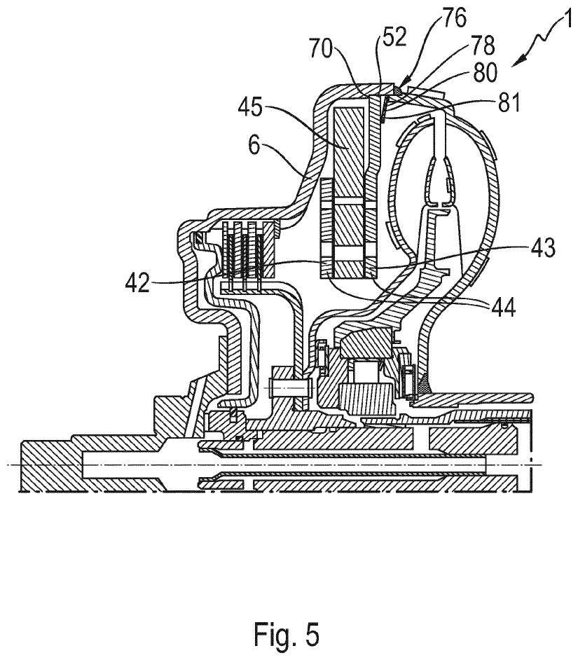

Also in the clutch arrangement 1 shown in FIG. 5, the cutout 52 of the second housing part 6 serves to receive the damper mass carrier element 43 of the damper mass carrier 44 which, for this purpose, protrudes farther radially outward than damper mass carrier element 42. The cutout 52 is provided with the axial stop 70 for axial support of the damper mass carrier element 43. The damper mass carrier element 43 is pressed against the axial stop 70 by an energy storage 80 of the energy storage device 78 of the clamping mechanism 76, preferably in the form of a Belleville washer 81, and is accordingly held in frictional engagement with the second housing part 6 as long as torques or torque surges acting in circumferential direction remain under the influence of the frictional force generated by the energy storage device 78. However, if the torques or torque surges acting in circumferential direction increase in strength to the extent that they exceed the frictional engagement produced by the energy storage device 78, the damper mass carrier 44 slips through relative to the housing 3 of the clutch arrangement 1 and accordingly limits the relative deflection of the damper masses 45 with respect to the damper mass carrier 44 by a limiting of the effective torques or torque surges.

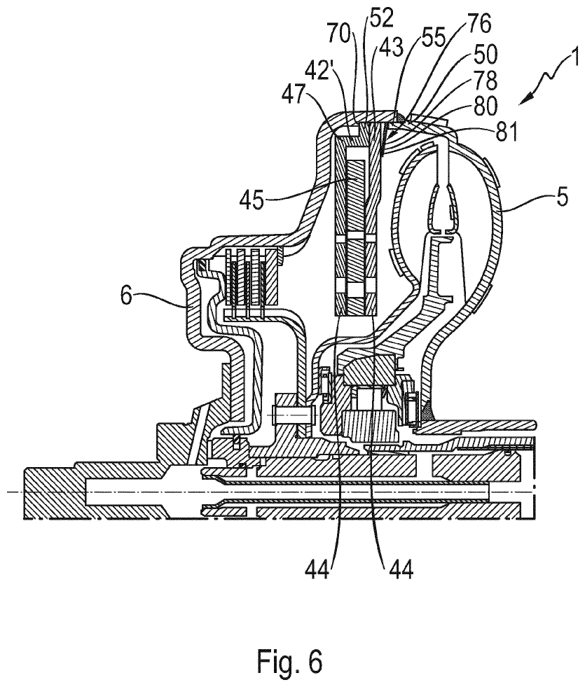

The clutch arrangement 1 shown in FIG. 6 substantially corresponds to the clutch arrangement 1 shown in FIG. 5, but the two damper mass carrier elements 42′ and 43 engage in the cutout 52 of the second housing part 6 for receiving the damper mass carrier 44. The damper mass carrier element 42′, which is accordingly lengthened radially outward is directed toward the other damper mass carrier element 43 in the extension area of the damper mass carrier element 42′ radially outside of the damper masses 45 by an offset 47 in order to penetrate into the cutout 52 in the area of its outer circumference at least substantially parallel to the damper mass carrier element 43. While the one damper mass carrier element 42′ is axially supported at the axial stop 70 of the cutout 52, the other damper mass carrier element 43 axially contacts the aforementioned damper mass carrier element 42′ under the influence of the energy storage 80 of the energy storage device 78 of the clamping mechanism 76, and the energy storage 80, which is preferably formed as Belleville washer 81 is supported on the one hand at the side of the damper mass carrier element 43 remote of the damper mass carrier element 42′ and, on the other hand, at the free end 55 of the projection 50 of the first housing part 5. As a result of the energy storage 80 of the energy storage device 78, the damper mass carrier elements 42′ and 43 of the damper mass carrier 44 are held so as to frictionally engage the second housing part 6 as long as torques or torque surges acting in circumferential direction remain under the influence of the frictional force generated by the energy storage device 78. However, if the torques or torque surges acting in circumferential direction increase in strength to the extent that they exceed the frictional engagement produced by the energy storage device 78, the damper mass carrier 44 slips through relative to the housing 3 of the clutch arrangement 1 and accordingly limits the relative deflection of the damper masses 45 with respect to the damper mass carrier 44 by a limiting of the effective torques or torque surges.

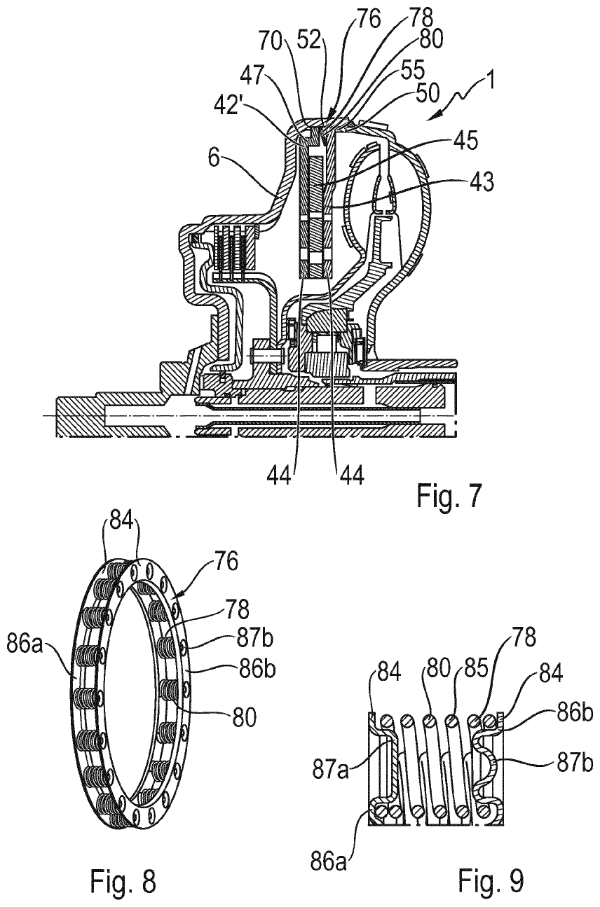

Also in the clutch arrangement 1 shown in FIG. 7, the two damper mass carrier elements 42′ and 43 of the damper mass carrier 44 are intended to engage in the cutout 52 of the second housing part 6, for which purpose the damper mass carrier element 42′ which is lengthened radially outward is directed toward the other damper mass carrier element 43 in the extension area of the damper mass carrier element 42′ radially outside of the damper masses 45 by an offset 47 in order to penetrate into the cutout 52 in the area of its outer circumference at least substantially parallel to the damper mass carrier element 43. While the one damper mass carrier element 42′ is axially supported at the axial stop 70 of the cutout 52, the other damper mass carrier element 43 axially engages with the free end 55 of the projection 50 of the first housing part 5 under the influence of the energy storage 80 of the energy storage device 78 of the clamping mechanism 76. Meanwhile, the energy storage 80 of the energy storage device 78 is arranged axially between the two damper mass carrier elements 42′ and 43 and accordingly causes an axial loading of the damper mass carrier elements 42′ and 43 in direction away from one another toward the respective support in the form of the axial stop 70 on the one hand and of the free end 55 of the projection 50 on the other hand. As a result of the energy storage 80 of the energy storage device 78, the damper mass carrier element 42′ is held to frictionally engage the second housing part 6 and the damper mass carrier element 43 is held so as to frictionally engage the first housing part 5 as long as torques or torque surges acting in circumferential direction remain under the influence of the frictional force generated by the energy storage device 78. However, if the torques or torque surges acting in circumferential direction increase in strength to the extent that they exceed this frictional engagement produced by the energy storage device 78, the damper mass carrier 44 slips through relative to the housing 3 of the clutch arrangement 1 and accordingly limits the relative deflection of the damper masses 45 with respect to the damper mass carrier 44 by a limiting of the effective torques or torque surges.

FIG. 8 shows an alternative energy storage device 78 of the clamping mechanism 76. Two energy storage carrier elements 86a, 86b, which are spaced apart axially from one another are provided to form an energy storage carrier 84. One of the energy storage carrier elements 86a is held to frictionally engage with the first damper mass carrier element 42′ under the influence of energy storages 80 of the energy storage device 78, and the other energy storage carrier element 86b is held to frictionally engage with the second damper mass carrier element 43 under the influence of the energy storage 80 of the energy storage device 78. FIG. 9 which depicts a circumferential segment of the energy storage carrier 84 shows how the energy storage carrier elements 86a, 86b have axial deformations 87a, 87b in each instance in the circumferential area of an energy storage 80 formed as helical compression spring 85 and so as to be axially directed toward this energy storage 80. The respective energy storage carrier element 86a, 86b positions the associated energy storage 80 in axial direction and in circumferential direction with these axial deformations 87a, 87b.

This energy storage device 78 can be used, for example, instead of the Belleville washer 81 shown in FIG. 7. Due to the fact that helical compression springs 85 are used, a more sensitive spring characteristic can be achieved compared to a Belleville washer 81. It will be appreciated that this energy storage device 78 can also be used in the other clutch arrangements discussed. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-14. (canceled)

15. Clutch arrangement comprising:
a mass damper system comprising:
a damper mass carrier; and
at least one damper mass deflectable relative to the damper mass carrier;
a housing comprising:
at least two housing parts permanently connected to one another by a fixed connection,
wherein at least one of the at least two which housing parts has a cutout for at least one projection of the other housing part,
wherein the at least two housing parts are assembled while receiving the damper mass carrier between an axial stop of the cutout of the one housing part and the at least one projection of the other housing part,
wherein the at least two housing parts are loaded over a course of producing the fixed connection by a clamping mechanism that acts on the at least two housing parts in a direction away from one another and which is operative axially between one of the at least two housing parts and the damper mass carrier, which is axially supported at the other respective housing part.

16. The clutch arrangement according to claim 15, further comprising:
a housing in which the cutout for the at least one projection and the at least one projection are provided, respectively, in a radial outer region of the housing and at an axial end of one respective housing part facing the other respective housing part,
wherein the housing part having the at least one projection engages with a radial inner side of the housing part having the cutout,
wherein the damper mass carrier is formed with at least one damper mass carrier element and, when the damper mass carrier engages in the cutout of the housing part having this cutout, the at least one damper mass carrier element is supported at the at least one projection by a side facing the at least one projection of the other housing part and/or is supported at an axial securing element associated with the cutout by a side remote of the at least one projection, while the at least one damper mass carrier element is acted upon by the clamping mechanism at the side remote of the support point.

17. The clutch arrangement according to claim 16,
wherein the damper mass carrier has a plurality of damper mass carrier elements,
wherein at least one of the damper mass carrier elements engage in the cutout of the housing part having this cutout,
wherein a respective damper mass carrier element is supported at the axial securing element associated with the cutout of the one housing part, and a further damper mass carrier element is supported at the at least one projection of the other housing part, while the side of the one damper mass carrier element remote of the axial securing element and the side of the further damper mass carrier element remote of the at least one projection are acted upon, respectively, by the clamping mechanism which is located axially between the two damper mass carrier elements.

18. The clutch arrangement according to claim 16,
wherein the damper mass carrier has a plurality of damper mass carrier elements,
wherein the damper mass carrier elements engage in the cutout of the housing part having this cutout,
wherein a first damper mass carrier element is supported at the axial securing element of this cutout, and a further damper mass carrier element is supported at the first damper mass carrier element, while a side of the further damper mass carrier element remote of the first damper mass carrier element is acted upon by the clamping mechanism supported at the at least one projection of the other housing part.

19. The clutch arrangement according to claim 16,
wherein the clamping mechanism is supported at the axial securing element associated with the cutout of the one housing part, and the damper mass carrier element is acted upon at its side remote of the at least one projection of the other housing part, while the damper mass carrier element is supported at the at least one is projection by a side facing this projection.

20. The clutch arrangement according to claim 16,
wherein the damper mass carrier element is supported at the axial securing element associated with the cutout of the one housing part and is acted upon by the clamping mechanism supported at the at least one projection of the other housing part.

21. The clutch arrangement according to claim 15, wherein the clamping mechanism has an energy storage device with at least one energy storage.

22. The clutch arrangement according to claim 21, wherein the energy storage device has at least one Belleville washer as the at least one energy storage.

23. The clutch arrangement according to claim 21, wherein the energy storage device has at least one wave spring as the at least one energy storage.

24. The clutch arrangement according to claim 21, wherein the energy storage device is provided with an energy storage which has energy storage carrier elements arranged at an axial distance from one another and which are provided with axial deformations which are provided for receiving the at least one energy storage so as to be secured in an axial direction and a circumferential direction.

25. The clutch arrangement according to claim 24, wherein the at least one energy storage received axially between the energy storage carrier elements is formed as helical compression spring.

26. The clutch arrangement according to claim 25, wherein a plurality of helical compression springs are arranged at least substantially equidistant from one another in circumferential direction are received axially between the energy storage carrier elements.

27. The clutch arrangement according to claim 17, wherein at least two damper mass carrier elements of the damper mass carrier protrude radially over the at least one damper mass, at least one of these damper mass carrier elements having at its radial outer side an offset directed toward the other respective damper mass carrier element.

28. The clutch arrangement according to claim 15, wherein the fixed connection between the housing parts is a weld.
